(19) United States
(12) Patent Application Publication
(10) Pub. No.: US 2026/0010709 A1
(43) Pub. Date: Jan. 8, 2026

(54) DECISION INTELLIGENCE-BASED COMPUTERIZED FRAMEWORK FOR DETERMINISTICALLY MANAGING, CONTROLLING, CREATING, SHARING AND HOSTING CIRCUIT DATA

(71) Applicant: CIRCUIT HOLDINGS, INC., Austin, TX (US)

(72) Inventors: Oeivind A. G. LOE, Austin, TX (US); George Tyson TUTTLE, Austin, TX (US)

(21) Appl. No.: 18/762,868

(22) Filed: Jul. 3, 2024

(51) Int. Cl. G06F 40/186; G06F 3/0486; G06F 40/106; G06F 40/169

(52) U.S. Cl. CPC G06F 40/186; G06F 3/0486; G06F 40/106; G06F 40/169

(57) ABSTRACT

A system and method for managing and curating electronic resources through interactive circuits. The system enables dynamic content curation and visualization, allowing users to organize and present information based on context and relevance. A collaborative authoring environment supports real-time co-editing, conflict resolution, and layered annotations, facilitating knowledge sharing and teamwork. The system incorporates a workspace feature that enhances user interaction with circuit content, enabling drag-and-drop functionality, annotation creation, and reference-first content management. This integrated approach streamlines information gathering, analysis, and dissemination, while maintaining content integrity and traceability. By leveraging advanced AI techniques and user-centric design, the system provides a comprehensive solution for managing complex information ecosystems, fostering collaboration, and extracting valuable insights from diverse data sources.

### BACKGROUND

In today's digital age, the volume of electronic resource information available is growing at an unprecedented rate. Organizations and individuals alike are struggling to effectively manage, organize, and utilize this vast amount of information. Traditional methods of information management, such as manually curating and sharing resources, are no longer sufficient to keep up with the ever-increasing influx of data. Moreover, the lack of efficient collaboration tools and the inability to personalize and contextualize information further exacerbate the challenges faced by users in accessing and leveraging relevant knowledge.

### BRIEF DESCRIPTION OF THE DRAWINGS

FIG. 1 is a block diagram illustrating components of a system for managing and curating electronic resource information by and between users according to some embodiments of the disclosure.

FIG. 2 is a flow diagram illustrating a method for updating circuit content based on content updates from data sources according to some embodiments of the disclosure.

FIG. 3A is a block diagram illustrating a user interface for editing a circuit displaying various components and features according to some embodiments of the disclosure.

FIG. 3B is a block diagram illustrating a user interface for viewing a circuit displaying various components and features according to some embodiments of the disclosure.

FIG. 4 is a flow diagram illustrating a method for generating a circuit user interface based on user context and circuit content according to some embodiments of the disclosure.

FIG. 5 is a flow diagram illustrating a method for collaborative authoring of a circuit according to some embodiments of the disclosure.

FIG. 6 is a flow diagram illustrating a method for facilitating a group chat within a circuit according to some embodiments of the disclosure.

FIG. 7 is a block diagram illustrating a user interface for a circuit workspace, illustrating various features for annotating, referencing, and interacting with circuit content according to some embodiments of the disclosure.

FIG. 8 is a flow diagram illustrating a method for utilizing a circuit workspace to annotate and reference content within a circuit according to some embodiments of the disclosure.

FIG. 9 is a flow diagram illustrating a method for prioritizing circuit documents based on user queries according to some embodiments of the disclosure.

FIG. 10 is a block diagram illustrating a computing device that may be used to implement various embodiments of the disclosure.

### DETAILED DESCRIPTION

In some implementations, the techniques described herein relate to a method including: receiving a request for a circuit, wherein the circuit includes a collection of electronic documents and resources organized based on context and relevance; loading circuit content and user context associated with the request; determining a circuit layout based on the user context and circuit content; generating a circuit user interface based on the circuit layout, wherein generating the circuit user interface includes selecting a layout template based on at least one of a manual user specification, a predefined circuit type, or an AI-based content analysis; and outputting the circuit user interface to a client device.

In some implementations, the techniques described herein relate to a method, further including analyzing new content from specific sources by flagging new documents for approval when not received from a allowlisted source; and prompting an author to review annotations on updated documents before incorporating the updated documents into the circuit.

In some implementations, the techniques described herein relate to a method, wherein determining the circuit layout includes: determining a semantic meaning of an intent statement associated with the circuit using natural language processing; and generating a layout that aligns the circuit with the semantic meaning of the intent statement.

In some implementations, the techniques described herein relate to a method, further including: providing a visual curation interface that allows an author to manually position widgets within the circuit layout while maintaining responsive flow of content.

In some implementations, the techniques described herein relate to a method, wherein generating the circuit user interface includes: creating a layout that combines manually curated sections with dynamically generated sections.

In some implementations, the techniques described herein relate to a method, further including: dynamically adjusting the circuit layout based on user interactions and queries while preserving manually defined elements.

In some implementations, the techniques described herein relate to a method including: initiating a collaboration session for a circuit, wherein the circuit includes a collection of electronic documents and resources; receiving changes to content of the circuit from multiple collaborators; resolving conflicts between the changes by applying at least one of: chronological prioritization, granular merging, user-defined conflict resolution rules, or AI-assisted conflict resolution; incorporating resolved changes into the circuit; maintaining a version history of the circuit, including records of changes made by each collaborator; and providing real-time updates and notifications to collaborators of changes to the content of the circuit.

In some implementations, the techniques described herein relate to a method, further including: implementing a layered annotation system that allows users to add annotations on top of existing annotations, creating a hierarchical structure of comments and discussions.

In some implementations, the techniques described herein relate to a method, wherein resolving detected conflicts includes: employing an AI-assisted conflict resolution system that analyzes semantic content of conflicting changes and suggests optimal merging strategies.

In some implementations, the techniques described herein relate to a method, further including: providing a shared chat interface within the collaboration session that integrates with an AI assistant, allowing multiple users to collectively interact with and receive responses from the AI assistant.

In some implementations, the techniques described herein relate to a method, further including: automatically adjusting a visibility and accessibility of collaborative features based on user roles and circuit permissions.

In some implementations, the techniques described herein relate to a method, wherein incorporating resolved changes into the circuit includes: updating linked references across interconnected circuits to maintain consistency when collaborative changes change shared content.

In some implementations, the techniques described herein relate to a method including: displaying a circuit within a workspace interface; enabling users to drag and drop content from the circuit into a workspace area; resolving references to original circuit content for dragged and dropped elements; allowing users to add annotations to the content within the workspace area, wherein the annotations include at least one of comments, explanations, questions, or tags; saving the annotations and associating them with corresponding circuit content; implementing a layered annotation structure, wherein subsequent annotations can be added as additional layers to existing annotations; providing tools for users to navigate and interact with the layered annotation structure; and saving the workspace area, including the annotations and organizational structure, as a new document within the circuit.

In some implementations, the techniques described herein relate to a method, further including: implementing a reference-first system that maintains active links between dragged content and its original source, enabling users to trace information back to its origin within the circuit.

In some implementations, the techniques described herein relate to a method, wherein saving the annotations includes: storing annotations separately from the original circuit content, allowing users to toggle visibility of personal and shared annotations independently.

In some implementations, the techniques described herein relate to a method, further including: providing multiple visualization options for dragged items in the workspace area, including full content display and representative reference formats.

In some implementations, the techniques described herein relate to a method, further including: automatically applying workspace annotations to the original circuit content, making additional information visible to other circuit users.

In some implementations, the techniques described herein relate to a method, further including: generating a knowledge graph based on connections and annotations created in the workspace area, visualizing relationships between different pieces of content.

In some implementations, the techniques described herein relate to a method, wherein saving the workspace area as a new document includes: assigning the new document associated with the workspace area a higher search rank within the circuit.

In some implementations, the techniques described herein relate to a method, further including: providing an interface within the workspace area that enables users to add content to other circuits, manage connectors, and view engagement.

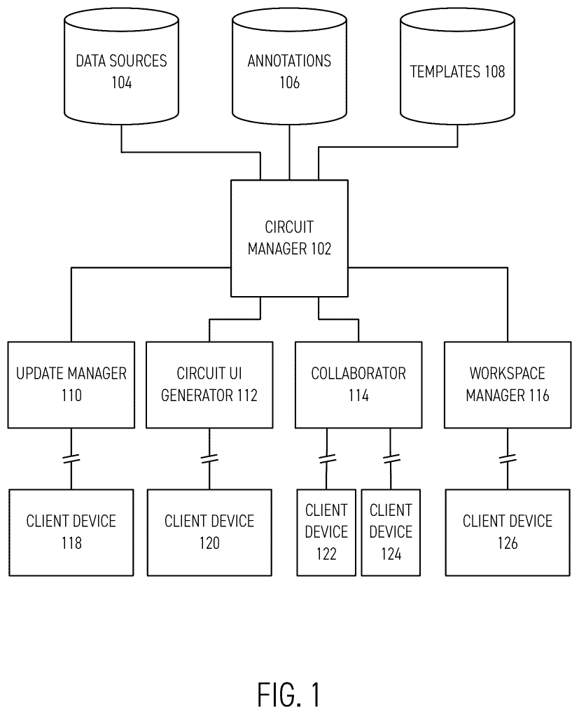

FIG. 1 is a block diagram illustrating components of a system for managing and curating electronic resource information by and between users according to some embodiments of the disclosure.

In some implementations, the system includes a circuit manager 102, data sources 104, annotation store 106, template database 108, an update manager 110, a circuit UI generator 112, a collaborator manager 114, and a workspace manager 116, all of which interact with client devices over a network. The specific number of client devices are not limiting. Further, no limit is placed on the number of unique users operating client devices except as noted herein.

In some implementations, circuit manager 102 is responsible for the overall management and curation of circuits within the system. As used herein, a circuit is a collection of electronic documents and resources that are organized and presented to users based on their context and relevance. Circuit manager 102 can handle the creation, storage, and retrieval of circuits, as well as the association of metadata and other relevant information with each circuit. Circuit manager 102 can also manage the relationships between circuits, such as hierarchical or linked structures, allowing for the creation of complex knowledge networks. Operational details of circuit manager 102 are described more fully in commonly owned application bearing attorney docket number 226144-010050 which is incorporated by reference herein in its entirety. In some implementations, circuit manager 102 enforces permissions and privileges at the system level, ensuring uniform application across all components, including the update manager 110, circuit UI generator 112, collaborator manager 114, and workspace manager 116.

Data sources 104 represent the various origins of content that can be ingested into circuits. These sources can include, but are not limited to, internal company databases, third-party content providers, public repositories, and user-generated content. Circuit manager 102 interacts with these data sources to retrieve and incorporate relevant documents and resources into circuits. The system supports a wide range of data formats and protocols, enabling the integration of diverse content types, such as text documents, images, videos, and structured data.

In some implementations, annotation store 106 can store user-generated or system-generated metadata associated with specific sections or elements within a circuit's content. Users can create annotations to highlight important information, provide context, or add their own insights and interpretations. Circuit manager 102 stores and manages these annotations, linking them to the appropriate content within the circuits. Annotations can be shared among users with appropriate permissions, fostering collaboration and knowledge sharing within the system.

One feature of the annotation system is its support for layered annotations. Layered annotations allow for multiple levels of annotations to be associated with a single piece of content, enabling users to build upon and respond to each other's insights and interpretations. In some implementations, when a user creates an annotation on a specific section or element within a document in a circuit, that annotation becomes the first layer. Subsequent users can then create additional annotations that reference or build upon the original annotation, forming a hierarchical structure of annotations. Each layer of annotation provides additional context, commentary, or feedback related to the previous layer.

For example, consider a research paper document within a circuit. The original author may create annotations highlighting key findings or methodologies. A reviewer may then add a second layer of annotations, providing comments or critiques on the author's annotations. Other researchers can further contribute by adding their own layers of annotations, discussing the implications of the findings or proposing alternative interpretations. These layered annotations can then be stored in annotation store 106 using a reference-first approach, where each annotation is linked to a specific section or element of the research paper document, ensuring that the annotations are always associated with their original context. This reference-first approach allows for efficient retrieval and display of annotations alongside the content they refer to, enabling users to easily understand the context and relationship between the annotations and the original document.

Layered annotations enable rich, in-depth discussions and collaborations around specific pieces of content. They allow users to engage in focused, contextual conversations, clarifying points, debating ideas, and sharing knowledge. Circuit manager 102 can maintain the relationships between the layers of annotations, ensuring that the hierarchical structure is preserved and easily navigable.

Users can view and interact with layered annotations in various ways. They can choose to view all layers simultaneously, providing a comprehensive overview of the discussions and insights related to a particular section of content. Alternatively, users can focus on specific layers, filtering out irrelevant or less important annotations to concentrate on the most valuable contributions. Annotation store 106 efficiently manages the storage and retrieval of layered annotations. It employs data structures and indexing mechanisms to ensure access to annotations based on their associated content, layers, and user permissions. Circuit manager 102 integrates with annotation store 106 to provide navigation and interaction with layered annotations within the circuits.

Layered annotations also play a role in update manager 110's functionality. When content within a circuit is updated or modified, update manager 110 intelligently maps the existing annotations, including their layers, to the updated version of the content, as will be discussed. Update manager 110 can ensure that the hierarchical structure of annotations is maintained and that users can continue to access and build upon the insights and discussions associated with the content, even as it evolves over time.

Furthermore, circuit UI generator 112 incorporates layered annotations into the dynamically generated user interfaces. It provides intuitive visual representations of the annotation layers, allowing users to easily navigate and interact with the hierarchical structure. Users can expand or collapse annotation layers, view individual annotations in detail, and contribute their own annotations seamlessly within the circuit interface.

In some implementations, template database 108 can store structures or layouts that can be applied to circuits to ensure consistency and facilitate the organization of content. Circuit manager 102 provides a set of default templates for various types of circuits, such as project documentation, research papers, or meeting notes. Users can also create custom templates tailored to their specific needs or organizational requirements. Templates define the overall structure, sections, and formatting of a circuit, making it easier for users to create and maintain well-organized and visually appealing circuits. In general, and as discussed further herein, templates can include the arrangement and configuration of widgets used to visualize circuit content. In some implementations, templates can specify widget types, their positioning, and data sources. As will be discussed, in some instances, template database 108 can cache automatically generated templates.

In some implementations, update manager 110 is responsible for handling updates to circuit content from various data sources. In some implementations, update manager 110 monitors the data sources 104 for changes and new additions and incorporates these updates into the relevant circuits. In some implementations, update manager 110 can detect and process content changes, ensuring that circuits remain up-to-date with the latest information.

One of the features of the update manager 110 is its ability to handle content updates in a context-aware manner. In some implementations, update manager 110 can analyze the incoming updates and determine their relevance and significance based on the circuit's existing content, user preferences, and system-defined rules. This context-aware approach allows the update manager 110 to prioritize and filter updates, presenting users with the most pertinent and valuable information.

In some implementations, update manager 110 can also handle the synchronization of annotations and other metadata associated with the updated content. When a document within a circuit is modified, the update manager 110 can map the existing annotations to the updated version, ensuring that user-generated insights and context are preserved. In cases where the mapping is ambiguous or conflicts arise, the update manager 110 can use conflict resolution techniques, such as prompting users for manual intervention or applying predefined rules to resolve discrepancies.

In some implementations, update manager 110 can include a content approval workflow. In some implementations, this workflow can provide multiple levels of content moderation and approval including, without limitation, a circuit-specific approval which relates to the intent of a given circuit. In this level, update manager 110 allows circuit owners or designated administrators to review and approve updates before they are incorporated into a live circuit. In some implementations, this level can ensure that the circuit content aligns with the circuit's purpose and relevance criteria. For example, a dog enthusiast club's circuit may use this feature to filter out content related to cats. In some implementations, this process can be assisted by an LLM or similar artificial intelligence to pre-screen content and suggest approvals or rejections based on the circuit's intent. In the second level, the method can provide platform-wide content moderation to prohibit abuse and ensure content safety. In this level, the content moderation may be performed by the system administrators. In some implementations, this system-level moderation can likewise be assisted using LLMs or other artificial intelligence. In some implementations, this second level of moderation can prevent inappropriate or harmful content across all circuits. As described, the content moderation approaches provide an additional layer of control and ensures that only verified and trusted content is made available to users both within specific circuits (and controlled by circuit participants) as well as across the entire system.

The circuit UI generator 112 is responsible for dynamically creating and rendering the user interface for circuits based on user context, preferences, and device capabilities. In some implementations, update manager 110 can use the template database 108 and the circuit's content to generate a personalized and intuitive interface that enables users to efficiently navigate and interact with the information within the circuit.

The circuit UI generator 112 can adapt the interface based on the user's role, permissions, and access rights. It presents relevant actions, tools, and options based on the user's privileges, ensuring that users can perform actions they are authorized to do while restricting access to sensitive or restricted content. Management by the circuit manager 102 combined with the adaptive interface enhances the user experience and promotes security and compliance within the system.

In some implementations, collaborator manager 114 facilitates real-time collaboration among users working on the same circuit. In some implementations, collaborator manager 114 can enable multiple users to simultaneously view, edit, and contribute to a circuit's content. In some implementations, collaborator manager 114 implements synchronization mechanisms to ensure that changes made by one user are instantly reflected across all collaborating users' interfaces, providing a seamless and interactive collaboration experience.

In some implementations, collaborator manager 114 also includes features for conflict resolution and version management. When multiple users make conflicting changes to the same content, the collaborator manager 114 can use merging algorithms to reconcile the differences and maintain a consistent and coherent version of the circuit. In some implementations, collaborator manager 114 keeps track of revision history, allowing users to review and revert changes if needed.

In some implementations, workspace manager 116 provides a dedicated environment for users to organize, analyze, and manipulate circuit content. It offers a range of tools and features that enable users to create custom views, apply filters, and perform advanced searches within a circuit. In some implementations, workspace manager 116 can allow users to save their personalized workspaces, making it easier to resume work and access frequently used content.

One of the features of the workspace manager 116 is the ability to create and manage annotations within the workspace. Users can select specific sections or elements of a circuit's content and add their own annotations, notes, or comments. These annotations are stored separately from the main circuit content, allowing users to maintain their personal insights and interpretations without modifying the original source material.

In some implementations, workspace manager 116 also enables users to establish relationships and connections between different pieces of content within a circuit. Users can create links, references, or associations between related documents, sections, or annotations, forming a interconnected web of knowledge. These connections facilitate navigation, discovery, and contextual understanding of the information within the circuit.

Additionally, in some implementations, workspace manager 116 supports the creation of visual representations and diagrams based on the circuit's content. Users can generate mind maps, flow charts, or other visual aids to better understand and communicate complex ideas or processes. These visual representations can be embedded within the circuit or exported for use in other applications.

The system interacts with multiple client devices 118, 120, 122, 124, and 126 over a network. No limitation is placed on the identify of client devices. Indeed, client devices 118, 120, 122, 124, and 126 may comprise disparate devices, the same device, or a combination of devices performing different aspects of the described functionality. These client devices represent the various platforms and devices through which users access and interact with the circuits. The system employs responsive design techniques and adaptive rendering to ensure that the circuit interfaces are optimized for different screen sizes, resolutions, and input methods, providing a consistent and user-friendly experience across devices.

The following is an example implementation of the above system. In some implementations, the system can be deployed on a scalable cloud infrastructure, leveraging containerization and orchestration platforms for efficient management and operation. The microservices architecture, data storage mechanisms, and security measures can be extended to accommodate the new components and functionalities.

The circuit manager 102, data sources 104, annotation store 106, and template database 108 can be implemented as interconnected microservices within a distributed architecture. The circuit manager 102 can be built using scalable and fault-tolerant technologies, such as a distributed database and a message queue system, to ensure the efficient creation, retrieval, and management of circuits. It can expose RESTful APIs for seamless integration with other components. The data sources 104 can be integrated through a modular and extensible connector framework, which allows for the easy addition of new data sources and the retrieval of data using standardized protocols. The annotation store 106 can be stored in a highly scalable and performant database system, such as a NoSQL database, which enables the efficient querying and retrieval of annotations based on various criteria. The template database 108 can be managed using a version-controlled repository and a template engine, allowing for the creation, modification, and rendering of templates using a declarative syntax. These components can work together, with the circuit manager 102 orchestrating the flow of data and ensuring the consistency and integrity of the circuits. The modular and loosely coupled nature of the microservices architecture allows for the independent scaling, updating, and maintenance of each component, ensuring the overall reliability and performance of the system.

Update manager 110 can be built using event-driven architectures, such as a publish-subscribe model or a message queue system. These architectures allow for the real-time processing of updates and the efficient distribution of information across the circuits. Update manager 110 can subscribe to relevant events from other components, such as the data sources 104 and the annotation store 106, and process these events to maintain the consistency and integrity of the circuit data. It can utilize techniques such as event sourcing and conflict resolution algorithms to handle concurrent updates and ensure data reliability.

The circuit UI generator 112 can generate a user interface implemented using modern front-end frameworks, such as React or Angular, which provide a component-based architecture for building dynamic and interactive user interfaces. These frameworks can be combined with server-side rendering techniques performed by the circuit UI generator 112 (subject to permissions granted by circuit manager 102), such as Next.js or Nuxt.js, to optimize the initial loading speed and improve the overall performance of the user interface. The circuit UI generator 112 can utilize reactive programming paradigms to efficiently update the UI, subject to permissions granted by circuit manager 102, based on changes in the underlying data, ensuring a smooth and responsive user experience. Ultimately, circuit UI generator 112 can deliver the generated user interface to client devices (e.g., client device 120).

Collaborator manager 114 can be built using collaboration frameworks, such as Operational Transformation (OT) or Conflict-Free Replicated Data Types (CRDT), which provide efficient mechanisms for managing concurrent edits and ensuring data consistency across multiple users. These frameworks can be integrated with real-time communication protocols, such as WebSocket or WebRTC, to enable instant updates and synchronization of changes among collaborators. Collaborator manager 114 can also utilize presence indicators and user avatars to enhance the collaborative experience and provide visual cues for user interactions.

Workspace manager 116 can be implemented using a combination of front-end and back-end technologies. On the front-end, it can leverage the same frameworks and libraries used by the circuit UI generator 112 to create a rich and interactive user interface. It can utilize client-side storage mechanisms, such as local storage or IndexedDB, to persist user preferences and workspace configurations. On the back-end, workspace manager 116 can be built as a microservice that exposes APIs for managing workspaces, storing and retrieving workspace data, and handling search and filtering operations. It can integrate with the circuit manager 102 and other components to provide a seamless and integrated experience for users.

To support advanced search capabilities, workspace manager 116 can incorporate full-text search engines, such as Elasticsearch or Apache® Solr, or also embedding-based vector search engines which provide powerful indexing and querying capabilities. These search engines can be integrated with the data sources 104 and the annotation store 106 to enable fast and efficient search across the entire circuit content. The workspace manager 116 can also utilize natural language processing techniques, such as named entity recognition and sentiment analysis, to enhance the search experience and provide more relevant results.

As will be discussed in more detail, the various components can utilize large language models (LLMs) and retrieval-augmented generation (RAG) techniques. These advanced technologies enable the circuits to understand and generate human-like text, provide context-aware responses, and enhance the overall information retrieval and content generation capabilities of the system. The integration of LLMs and RAG represents a substantial advancement, unlocking new possibilities for user interaction and knowledge discovery.

To optimize public circuits for search engines, the system employs server-side rendering (SSR) techniques. All public circuits are rendered on the server before being sent to the client, ensuring that search engine crawlers can effectively index the content. This SSR approach includes generating meta tags, structured data, and other SEO-friendly elements dynamically based on the circuit's content. The system also creates a sitemap of public circuits to facilitate comprehensive indexing. These SEO optimizations enhance the discoverability of circuits through search engines, increasing their visibility and accessibility to potential users.

In summary, the system provides a comprehensive and flexible solution for managing and curating circuits of electronic resources. Circuit manager 102, update manager 110, circuit UI generator 112, collaborator manager 114, and workspace manager 116 work together to create a dynamic and interactive environment for users to access, update, collaborate on, and analyze circuit content. The system's context-aware approach, personalized interfaces, and real-time collaboration features enhance the user experience and facilitate efficient knowledge management and sharing within organizations.

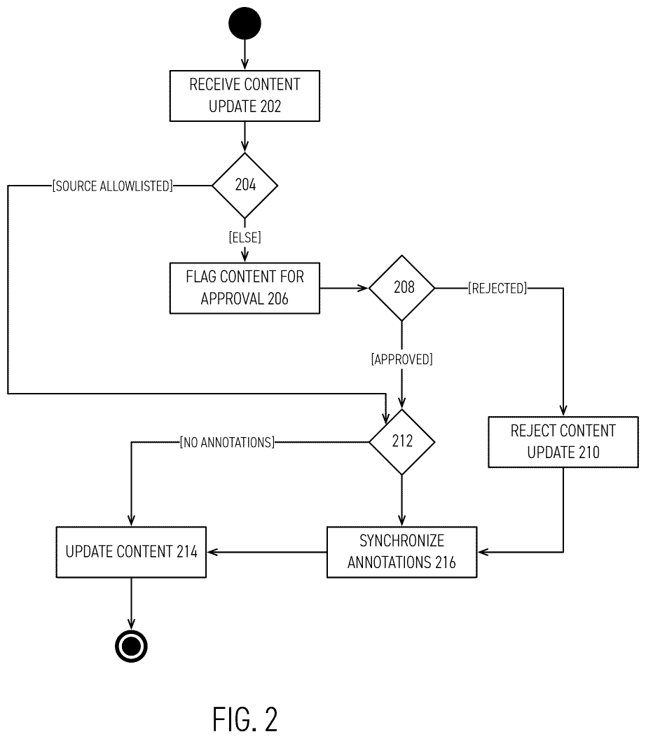

FIG. 2 is a flow diagram illustrating a method for updating circuit content based on content updates from data sources according to some embodiments of the disclosure.

In step 202, the method can include receiving a content update from various data sources for a document in a circuit.

These updates can originate from a wide range of sources, such as internal databases, external APIs, user-generated content, or automated data feeds. The updates may include new documents, modifications to existing documents, or the removal of outdated content. The frequency and volume of updates can vary depending on the nature of the data sources and the circuit's requirements.

In step 204, the method can include determining whether the source of the update is allowlisted.

An allowlist is a predefined list of trusted sources from which content updates are automatically accepted without further verification. This step helps streamline the update process for reliable and verified sources, reducing the need for manual intervention.

If the source is allowlisted, the method proceeds directly to step 212, where the method checks whether there are any annotations associated with the updated content, as will be described later herein.

If the source is not allowlisted, the method proceeds to step 206, where the content update is flagged for approval. This step can include notifying the designated approvers, such as circuit administrators or content moderators, about the pending update. The notification can be sent through various channels, such as email, in-app notifications, or via a dedicated approval workflow system.

In step 208, the method can include awaiting approval for the flagged update.

In some implementations, the approvers can review the content update to assess its relevance, quality, and appropriateness for inclusion in the circuit. They may consider factors such as the credibility of the source, the accuracy and completeness of the information, and the potential impact on the circuit's users. Collaboration tools and discussion forums can be utilized to facilitate the review process and gather input from multiple stakeholders.

If the content update is approved, the method proceeds to step 212, and the approved update is forwarded to step 214 for integration into the circuit. If the update is rejected, the method moves to step 210, where the rejected update is handled.

Depending on the specific implementation and policies, rejected updates may be discarded, archived for future reference, or returned to the source for further refinement or clarification. Feedback can be provided to the source to indicate the reasons for rejection and suggest potential improvements.

After the content update is either approved or rejected, the method checks in step 212 whether there are any annotations associated with the updated content.

Annotations refer to user-generated notes, comments, or metadata attached to specific sections or elements within the circuit's content or to the entire document itself. If annotations are present, the method proceeds to step 216, where the annotations are synchronized with the updated content.

In step 216, the method can include synchronizing the annotations with the updated content.

In some implementations, this synchronization process may involve user intervention in certain cases. For instance, when an updated document arrives and there are existing annotations on the document in the circuit, the system may prompt the author to review whether the annotations are still correct and applicable to the updated content. This review step ensures the continued relevance and accuracy of annotations in light of content changes. The synchronization process may pause, waiting for the author's input before proceeding with the update. This user-involved synchronization may be used to maintain the integrity of layered annotations, where multiple users may have contributed interconnected comments and insights.

In some implementations, the annotation synchronization process can include several steps. First, the method can identify the specific content elements that have been updated and their corresponding annotations. It can then analyze the changes made to the content and determine how they impact the associated annotations. For example, if a paragraph is modified or moved within a document, the annotations linked to that paragraph need to be adjusted accordingly.

Next, the method can map the annotations to the updated content. This may involve techniques such as text matching, semantic analysis, and machine learning to accurately align the annotations with the corresponding content elements. In cases where the mapping is ambiguous or conflicts arise, the method may employ conflict resolution strategies, such as prompting the annotation authors for manual review or applying predefined rules to make the final decision.

Once the annotations are successfully mapped to the updated content, the method synchronizes the annotations by updating their references, positions, and any relevant metadata. This ensures that the annotations remain accurately linked to the appropriate content elements and maintain their contextual relevance. The synchronized annotations are then stored for future retrieval and display.

If there are no annotations associated with the updated content, or after the annotation synchronization process is complete, the circuit content update process proceeds to step 214 where the content is updated, and the circuit is ready for use with the latest content and annotations. This can include integrating the new or modified content into the existing circuit structure, updating any relevant metadata or indexes, and ensuring the consistency and integrity of the circuit data. The update process may include various data validation, transformation, and normalization techniques to maintain the quality and compatibility of the content. Since annotations and documents are stored independently, the method may update the content or annotations in any order.

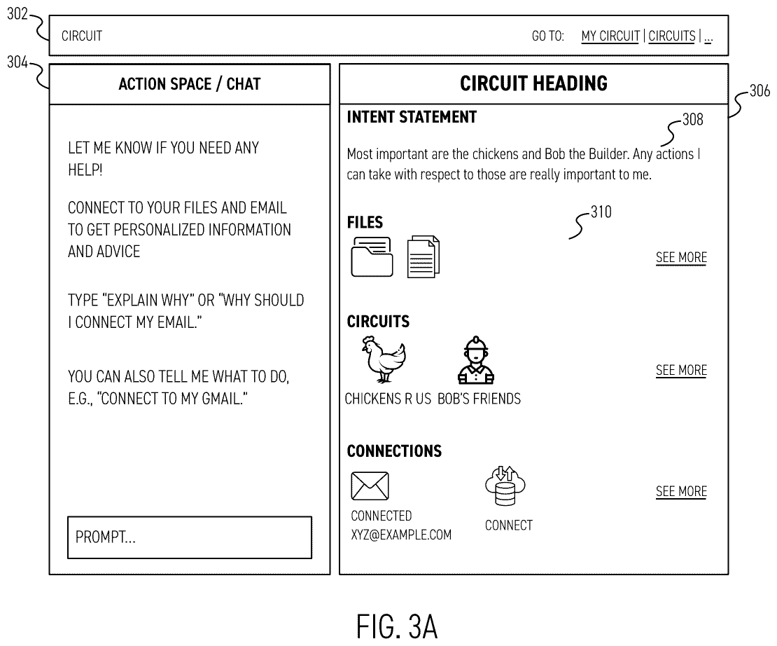

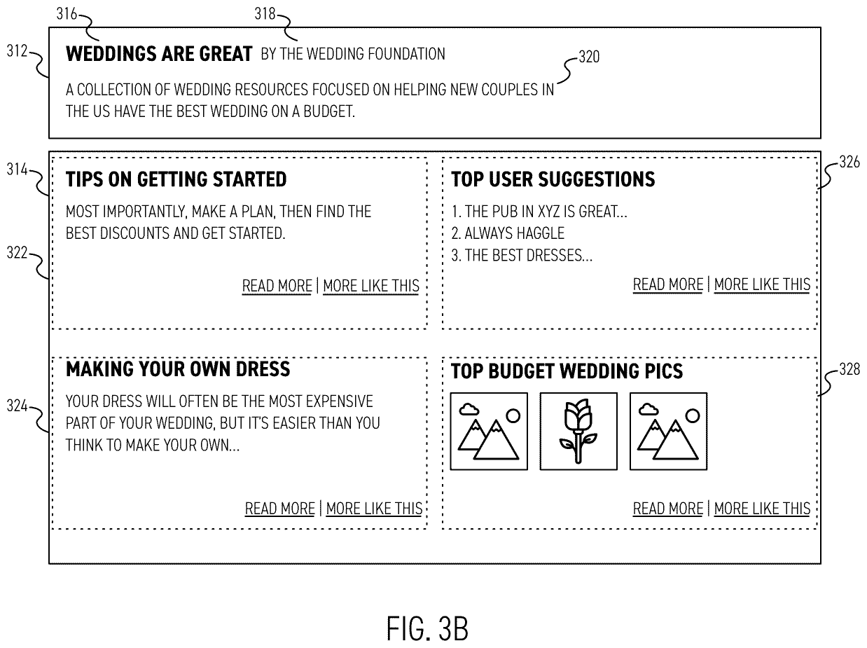

FIG. 3A is a block diagram illustrating a user interface for editing a circuit displaying various components and features according to some embodiments of the disclosure.

As illustrated, the UI includes a header 302 with general site navigation.

This header 302 provides users with quick access to essential features and sections of the circuit management system. The navigation menu within the header allows users to easily switch between different circuits, access their personal profile, and navigate to other key areas of the system, such as a dashboard, settings, or help resources.

The UI further includes a chatbot interface 304 that enables users to interact with the circuit using natural language.

The chatbot interface leverages advanced natural language processing (NLP) and machine learning techniques (e.g., LLMs including RAG-based LLMs) to provide users with a conversational and intuitive way to explore and interact with the circuit's content (e.g., documents, annotations, etc.). Users can ask questions, request information, or provide instructions to the chatbot, which interprets the user's input and generates relevant responses or actions. As discussed, when implemented using RAG-based LLMs the chatbot can provide highly relevant and contextually relevant answers to user questions.

The chatbot interface 304 may include a text input field where users can type their queries or commands, as well as a display area where the chatbot's responses are presented. The chatbot may utilize visual elements, such as cards, images, or formatted text, to enhance the clarity and readability of its responses. Additionally, the chatbot may provide suggestions or prompts to guide users in their interactions and help them discover relevant content or features within the circuit. In some implementations, the chatbot interface 304 can display circuit documents or representations thereof (e.g., snippets, thumbnails, etc.).

The UI further includes a main circuit editing area 306. The main circuit editing area 306 provides an interface for circuit authors to modify and organize the circuit's content and structure. This area includes several components designed to allow for circuit management and customization, as discussed herein.

The main circuit editing area 306 further includes an intent statement 308 that guides how the circuit is processed and displayed.

The intent statement may be a declarative expression of the desired outcome or purpose of the circuit. It serves as a high-level directive that influences how the circuit's content is organized, prioritized, and presented to users. The intent statement may be entered by the circuit creator or administrator and can be updated as the circuit evolves.

The system can use natural language processing and machine learning algorithms (e.g., LLMs) to interpret the intent statement and align the circuit's content accordingly. It analyzes the semantic meaning behind the statement and considers factors such as keywords, sentiment, and context to determine the most relevant and meaningful way to structure and display the circuit's information. Details of such organization are provided later herein.

Based on the intent statement, the system may automatically categorize and tag content, apply filters or rankings, and generate dynamic layouts or navigational elements to guide users towards the most pertinent information. The intent statement acts as a central reference point, ensuring that the circuit remains focused and coherent, even as new content is added or updated.

The main circuit editing area 306 further includes a connector interface 310.

In some implementations, connectors are pre-built integrations that allow the circuit to seamlessly access and import content from various external sources or other circuits. The connector interface provides users with a user-friendly way to configure and manage these integrations. The interface may include a list or grid of available connectors, each representing a specific external platform, service, or data source.

In the given example, three types of connector instances in use in the circuit are illustrated:

Files Connector: This connector enables users to import files from their local device or cloud storage services into the circuit. Users can browse their file system, select the desired files, and upload them directly into the circuit. The connector may support various file formats, such as documents, spreadsheets, presentations, images, and videos.

Circuit Connector: This connector allows users to establish connections between different circuits. Users can search for and select other circuits that are relevant to the current circuit's content or purpose. Once connected, the circuit can import and synchronize content from the linked circuits, enabling seamless integration and cross-referencing of information.

Connected Resource Connector: This connector enables users to integrate external web resources, such as websites, blogs, or online databases, into the circuit. Users can provide the URL or API endpoint of the external resource, and the connector will fetch and import the relevant content into the circuit. The connector may offer options to specify the content type, update frequency, and authentication settings.

Certainly, many other types of connectors may be implemented and used and the examples above are not limiting.

The connector interface simplifies establishing and managing connections to content sources. Users can configure the connectors, set up automatic synchronization schedules, and monitor the status of the imported content. The interface may also provide options to filter, transform, or map the imported data to ensure compatibility and consistency with the circuit's structure and formatting.

By leveraging connectors, the circuit can aggregate and centralize content from multiple sources, creating a comprehensive and up-to-date knowledge repository. This integration capability enhances the circuit's value and utility, enabling users to access and analyze information from diverse sources within a single, unified interface.

FIG. 3B is a block diagram illustrating a user interface for viewing a circuit displaying various components and features according to some embodiments of the disclosure.

As illustrated, the user interface of FIG. 3B presents a circuit and its underlying documents to a user. In the illustrated implementation, the user interface includes a header area 312 and a main area 314. The header area 312 includes a title 316, author identifier 318, and intent statement 320. The main area 314 includes a plurality of widgets (322, 324, 326, 328) that display the circuit content.

In some implementations, the intent statement 320 can be used to determine the results displayed in the main area, ensuring that the content aligns with the circuit's purpose. For example, the UI generator can determine a semantic meaning of an intent statement 320 associated with the circuit using natural language processing and generate a layout that aligns the circuit with the semantic meaning of the intent statement. Further, the intent statement 320 can inform viewers of the purpose of the circuit. In some implementations, title 316 can be used in a similar manner while author identifier 318 can ensure attribution of circuits.

The main area 314 is the central hub where the circuit's content is presented to users for editing. It can dynamically render the documents, data, and other electronic resources that make up the circuit. The display area may utilize a flexible and responsive layout to accommodate different types of content and optimize the viewing experience across various devices and screen sizes.

The main area 314 may include features such as pagination, scrolling, or infinite loading to handle large amounts of content. It may also provide options for users to customize the view, such as adjusting font sizes, applying themes, or toggling between different layout modes (e.g., grid view, list view).

Interactive elements within the main area 314 allow users to engage with the content directly. Users can click on documents to open them, hover over elements to reveal additional details, or use contextual menus to access specific actions or options. The main area 314 may also incorporate collaborative features, such as annotations, comments, or real-time co-editing, to facilitate teamwork and knowledge sharing among users.

The main area 314 includes a plurality of widgets (322, 324, 326, 328) that display the circuit content in various formats. These widgets represent a mix of content types and presentation styles, tailored to provide an optimal viewing experience for the circuit's information. As discussed further herein, layouts of such widgets can be performed manually, semi-automatically, or fully automatically.

In the illustrated user interface, widget 322 (“TIPS ON GETTING STARTED”) may be implemented as a direct RAG-based LLM result. Specifically, this type of widget can present information that has been dynamically generated or retrieved based on the circuit's content and the user's context, leveraging advanced language models to provide relevant and concise information. In some implementations, the content displayed in widget 322 may be synthesized from multiple documents within the circuit, using retrieval-augmented generation techniques. Alternatively, or in conjunction with the foregoing, the widget 322 may utilize an LLM to generate novel tips and advice based on the overall theme and content of the circuit, ensuring that the information presented is both relevant and up-to-date.

In the illustrated user interface, widget 324 (“MAKING YOUR OWN DRESS”) may be implemented as a more detailed, article-style content within the circuit view. This widget demonstrates the system's ability to seamlessly integrate longer-form content alongside more concise information snippets. In some implementations, this content can map to a document or portion of document. Alternatively, or in conjunction with the foregoing, the widget 324 may automatically generate longer-form content based on the circuit documents using, as one example, an LLM or other type of natural language generative model.

In the illustrated user interface, widget 326 (“TOP USER SUGGESTIONS”) may be implemented as a result group that aggregates and displays top contributions from users (e.g., annotations, chat session messages, etc.). Specifically, this collaborative feature allows for the incorporation of user-generated content and insights, enriching the circuit with community knowledge. In some implementations, the system may use machine learning algorithms to rank and select the most relevant or helpful user contributions for display. Alternatively, or in conjunction with the foregoing, the widget 326 may employ natural language processing techniques to summarize or highlight key points from longer user contributions, ensuring that the displayed content remains concise and informative within the limited widget space.

In the illustrated user interface, widget 328 (“TOP BUDGET WEDDING PICS”) illustrates how visual content can be incorporated into the circuit view, presenting a gallery of images relevant to the circuit's theme. This multi-modal approach allows for a rich and diverse presentation of information. In some implementations, the images displayed in widget 328 may be sourced directly from documents within the circuit, such as embedded images in articles or user-uploaded photos. Alternatively, or in conjunction with the foregoing, the widget 328 may utilize computer vision and image recognition algorithms to automatically select and curate relevant images from a larger pool of visual content associated with the circuit. The system may also employ machine learning techniques to rank the images based on factors such as relevance to the “budget wedding” theme, visual appeal, and user engagement metrics. Additionally, the widget may incorporate AI-generated or AI-enhanced images that are created based on the textual content and context of the circuit, providing visual representations of concepts discussed in the circuit even when original images are not available.

Each widget includes interactive elements to enhance user engagement and exploration. The “READ MORE” option allows users to expand the widget and continue reading within the application, providing a seamless in-app reading experience. This feature will also support further interactions with the expanded content, although these are not explicitly shown in the current figure. The “MORE LIKE THIS” option applies a query to find and display similar content, enabling users to get further information regarding specific topics of interest.

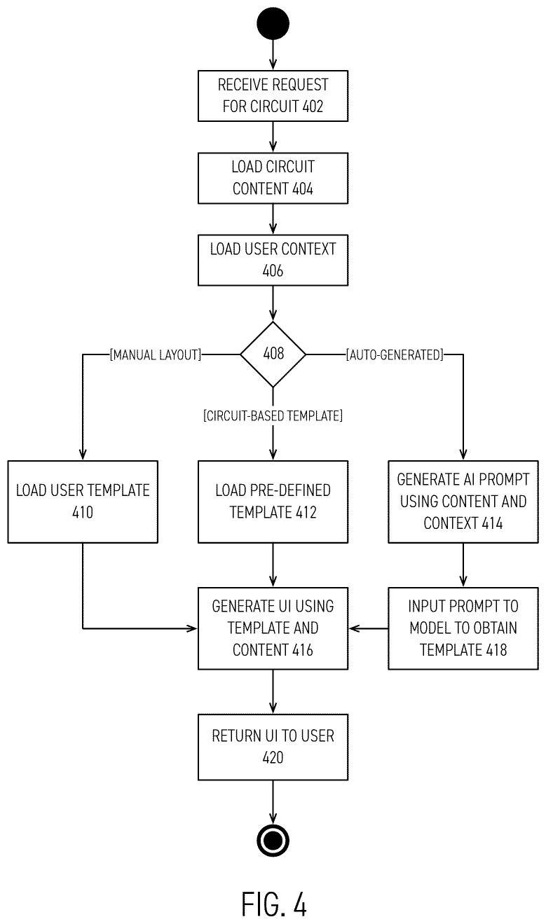

FIG. 4 is a flow diagram illustrating a method for generating a circuit user interface based on user context and circuit content according to some embodiments of the disclosure.

In step 402, the method can include receiving a request for a circuit.

This step involves a user or an external system initiating a request to access or view a specific circuit. The request may include parameters such as the circuit identifier, user credentials, or any other relevant information needed to retrieve the desired circuit.

In step 404, the method can include loading the circuit content.

Upon receiving the request, the system retrieves the circuit content from the underlying storage or database. This step may involve querying the relevant data sources, such as the document store, annotation store, or any other repositories associated with the circuit. The retrieved content may include documents, data, metadata, and any other electronic resources that constitute the circuit.

In step 406, the method can include loading the user context.

In this step, the system retrieves and analyzes the user context associated with the requesting user. The user context represents a collection of information that describes the user's preferences, behavior, psychographic qualities, and interaction history within the circuit management system. It may include data such as user profile information, previous search queries, viewed documents, annotations, collaborators, and any other relevant user-specific data. In some implementations, user context may be supplied by users via a form or other interface.

In some implementations, the system may also leverage various data sources to gather the user context, such as user profiles, activity logs, session data, or external systems. The user context helps personalize the circuit user interface and tailor the content and features to the individual user's needs and interests.

In step 408, the method can include determining the circuit layout based on the user context and circuit content. In some implementations, prior to determining the circuit layout, the method can include applying the user context to the circuit content to determine what information to show to the user and to rank the importance of the information to be displayed. This pre-processing can be used to ensure that the most relevant and significant content is prioritized based on the user's specific context, preferences, and needs.

Using the loaded circuit content and user context, the system can determine the optimal layout for presenting the circuit to the user. The layout defines the structure, organization, and visual arrangement of the circuit's content and interactive elements within the user interface.

The system can employ advanced algorithms and machine learning techniques to analyze the circuit content and user context to make informed decisions about the layout. It considers factors such as the nature and volume of the content, the user's preferences and behavior, the device type and screen size, and any predefined layout templates or rules.

The layout determination process may involve techniques such as content categorization, relevance scoring, or collaborative filtering to prioritize and organize the content based on the user's context. The system may also apply design principles and usability best practices to ensure a clear, intuitive, and visually appealing layout.

If the circuit has a manually defined layout, the method proceeds to step 410, where the user-specified template is loaded.

In this case, the circuit creator or administrator has explicitly defined a custom layout template for the circuit. The system retrieves this predefined template, which dictates the specific arrangement and presentation of the circuit's content. The manual layout template overrides any automatically generated layouts and provides a consistent and controlled visual experience for users accessing the circuit.

To facilitate the creation of manual layout templates, the system provides a What You See Is What You Get (WYSIWYG) editor. This intuitive visual editor allows circuit creators and administrators to design and customize the layout without requiring extensive coding knowledge. Users can drag and drop various UI elements, such as text boxes, image placeholders, widgets, and interactive components, onto a canvas that represents the circuit interface. The WYSIWYG editor offers real-time previews, enabling users to see how their changes will appear in the final layout. It also provides options for adjusting element sizes, positions, colors, and other styling properties. Advanced users can access HTML and CSS editing capabilities within the WYSIWYG interface for more granular control. This approach empowers users to create visually appealing and functionally rich custom layouts that precisely match their circuit's needs and branding requirements.

If the circuit has a predefined template based on the circuit type or category, the method moves to step 412, where the corresponding predefined template is loaded.

The system maintains a library of predefined layout templates that are optimized for different types or categories of circuits. For example, there may be specific templates for research papers, project documentation, or data visualizations. These templates are designed to provide a standardized and effective presentation for circuits belonging to particular domains or serving specific purposes.

The system identifies the appropriate predefined template based on the circuit's type or category and retrieves it from the template library. The predefined template is then used as the basis for rendering the circuit user interface. In some implementations, a RAG-based LLM (or similar method or technique) can be used to determine the type of circuit. [symbol] For example, such an LLM utilizes the circuit documents a prompt could be input into the LLM asking for a classification based on the underlying circuit documents.

[symbol]

If there is no manual or predefined template, the method proceeds to step 414, where an AI-based content analysis is performed to generate the circuit layout dynamically.

In this case, the system leverages advanced artificial intelligence and natural language processing techniques to analyze the circuit content and user context to generate an optimal layout on-the-fly. The AI algorithms examine the semantic structure, relationships, and relevance of the content, as well as the user's preferences and behavior patterns, to determine the most effective way to organize and present the information.

The AI-based layout generation may involve techniques such as topic modeling, entity recognition, sentiment analysis, or graph analysis to identify key themes, relationships, and patterns within the content. The system may also consider factors such as the user's role, expertise level, or collaboration history to adapt the layout to their specific needs and context.

In step 418, if an AI-generated layout is used, the method can include inputting the AI-generated layout as a prompt to a generative AI model to refine and enhance the layout.

The system feeds the AI-generated layout as a prompt to the generative AI model, along with any additional context or constraints. The generative AI model then processes the prompt and generates an enhanced version of the layout, incorporating its learned patterns, design principles, and domain knowledge.

The refined layout may include improvements such as optimized content placement, visual hierarchy, color schemes, or typography. The generative AI model may also suggest additional elements or modifications to enhance the user experience and align with best practices. If an AI-generated layout is used, the system can further refine and enhance the layout using generative AI models. The AI-generated layout serves as a prompt for these models, which can suggest improvements in content placement, visual hierarchy, color schemes, and typography. This approach leverages advanced AI capabilities to create highly tailored and visually appealing layouts that adapt to the specific content and user context of each circuit.

The use of generative AI models allows for the creation of highly tailored and visually appealing layouts that adapt to the specific content and user context of each circuit. It leverages the power of AI to generate layouts that are not only functional but also aesthetically pleasing and engaging.

In an implementation, a RAG-based LLM can be used to determine the actual layout. In this implementation, the LLM may also utilize documentation describing the layout options for various circuits. For example, design documentation can be supplied to the LLM to allow it to generate the final layout, using the design documentation as a reference guide and the content of the circuit as the underlying content. Additionally, the LLM may utilize past templates and layouts [symbol] , as well as the underlying content used to generate them to help guide its decision making.

In step 416, the method can include generating the circuit user interface based on the determined layout.

Using the layout obtained from one or more of steps 410, 412, or 414, the system dynamically generates the circuit user interface. This step involves rendering the content, interactive elements, and navigational components according to the specified layout structure.

The user interface generation process may involve techniques such as HTML/CSS rendering, JavaScript manipulation, or native mobile app development, depending on the target platform and device. The system may also apply responsive design principles to ensure that the user interface adapts seamlessly to different screen sizes and device capabilities.

The generated user interface includes the main content area, where the circuit's documents, data, and resources are displayed. It may also incorporate interactive features such as search functionality, filtering options, or collaboration tools based on the user's context and the circuit's requirements.

In addition to the main content area, the user interface may include peripheral components such as navigation menus, breadcrumbs, or contextual help and guidance. These components assist users in navigating the circuit, accessing related content, and discovering relevant features and actions.

Finally, in step 420, the method can include returning the generated circuit user interface to the user.

Once the circuit user interface has been generated and optimized, it is sent back to the user who initiated the request in step 402. The user's device receives the user interface data and renders it within their web browser, mobile app, or any other compatible viewing application.

The user can then interact with the circuit through the provided user interface, accessing the content, utilizing the available features and tools, and collaborating with others as needed. The circuit user interface serves as the primary means for users to explore, analyze, and contribute to the circuit's knowledge and insights.

Throughout the user's session, the system may continue to monitor their interactions and behavior, capturing additional user context data. This data can be used to further refine and personalize the user interface in real-time or for future sessions, ensuring a continuously evolving and adaptive user experience.

Overall, the method described in FIG. 4 demonstrates a sophisticated approach to generating circuit user interfaces that are tailored to individual users' needs and preferences. By leveraging user context, circuit content, predefined templates, and AI-driven layout generation, the system creates highly personalized and intuitive interfaces that enhance user engagement, productivity, and knowledge discovery within the circuit management system.

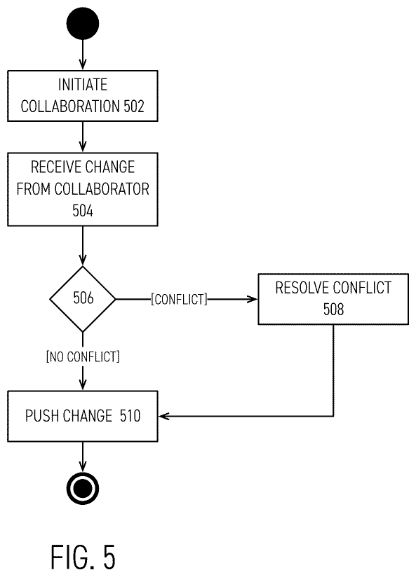

FIG. 5 is a flow diagram illustrating a method for collaborative authoring of a circuit according to some embodiments of the disclosure.

In step 502, the method can include initiating a collaboration session for a circuit.

This step can involve a user, typically the circuit owner or an authorized collaborator, starting a collaboration session within the circuit management system. The collaboration session enables multiple users to simultaneously work on the same circuit, share ideas, and contribute content in real-time.

The initiation of the collaboration session may be triggered through various actions, such as inviting collaborators, sharing a collaboration link, or accessing a shared workspace within the circuit. The system may prompt the user to specify the desired collaborators, set access permissions, and define the scope of the collaboration.

In step 504, the method can include receiving changes or contributions from collaborators.

Once the collaboration session is initiated, collaborators can actively participate in authoring and editing the circuit's content. They can make changes, add new information, suggest edits, or provide annotations within the collaborative environment.

Collaborators may contribute through various means, such as directly editing the circuit's documents, adding annotations or comments, uploading new files, or proposing structural changes to the circuit's organization. The system captures and records these changes in real-time, ensuring that all collaborators have access to the most up-to-date version of the circuit.

The collaboration interface may provide features such as real-time co-editing, where multiple collaborators can simultaneously work on the same document or section of the circuit. It may also include communication tools, such as chat or commenting functionality, to facilitate discussions and decision-making among collaborators. As described further herein, the method may provide a collaborative AI chatbot interface to allow for multi-user chatbot sessions.

In step 506, the method can include checking for conflicts or simultaneous changes made by multiple collaborators.

As multiple collaborators contribute to the circuit concurrently, there is a possibility of conflicts or overlapping changes. The system continuously monitors the changes made by each collaborator and checks for any conflicts or inconsistencies.

Conflicts can arise when two or more collaborators make simultaneous edits to the same piece of content, such as editing the same paragraph or modifying the same data point. The system detects these conflicts by comparing the changes made by each collaborator against the latest version of the circuit.

If no conflicts are detected, the method proceeds to step 510, where the changes are merged and incorporated into the circuit.

However, if conflicts are identified, the method moves to step 508, where conflict resolution mechanisms are applied.

In step 508, the method can include resolving conflicts or merging changes intelligently.

When conflicts are detected, the system employs intelligent algorithms and techniques to automatically resolve them whenever possible. The conflict resolution process may involve various strategies, such as:

Chronological priority: The system may give precedence to the changes made by the collaborator who submitted their edits first. The later changes may be treated as subsequent revisions or suggestions.

Granular merging: The system may attempt to merge the conflicting changes at a granular level, such as combining non-overlapping edits or preserving the common parts of the modifications made by different collaborators.

User-defined rules: The system may follow predefined rules or guidelines set by the circuit owner or administrators to determine how conflicts should be resolved. These rules may specify the priority of certain collaborators (e.g., owners having high precedence than authors) or establish a hierarchy for decision-making.

AI-assisted resolution: The system may leverage artificial intelligence and machine learning techniques to analyze the conflicting changes and suggest the most appropriate resolution based on factors such as context, semantic similarity, or historical patterns.

In cases where the system cannot automatically resolve the conflicts, it may prompt the collaborators involved to manually review and decide on the final version. The collaborators can discuss the conflicting changes, negotiate a resolution, and reach a consensus on how to proceed.

The conflict resolution process ensures that the integrity and consistency of the circuit's content are maintained, even in the presence of simultaneous edits from multiple collaborators.

In step 510, the method can include incorporating the changes into the circuit.

Once the conflicts, if any, are resolved, the system incorporates the approved changes into the circuit. This step involves updating the relevant documents, data, and metadata to reflect the modifications made by the collaborators.

The incorporation of changes may include tasks such as merging text edits, updating data values, adding or removing files, or restructuring the circuit's organization based on the collaborators' contributions. The system ensures that the changes are seamlessly integrated into the existing content, maintaining the overall coherence and integrity of the circuit.

After the changes are incorporated, the updated version of the circuit becomes the new authoritative version. All collaborators working on the circuit will have access to this updated version, reflecting the collective contributions and modifications made during the collaboration session.

The system may also maintain a version history or audit trail, recording the changes made by each collaborator and the corresponding timestamps. This history enables collaborators to review previous versions, understand the evolution of the circuit, and revert to earlier states if needed.

Throughout the collaboration process, the system may provide real-time updates and notifications to all collaborators, ensuring that everyone is aware of the changes being made and has the opportunity to review and provide feedback. Collaboration tools, such as commenting, mentioning, or task assignments, facilitate effective communication and coordination among collaborators.

The collaborative authoring process described in FIG. 5 promotes seamless teamwork, knowledge sharing, and collective intelligence within the circuit management system. By enabling multiple users to contribute simultaneously and providing mechanisms for conflict resolution and merging, the system fosters a dynamic and inclusive environment for circuit development and refinement.

Collaborative authoring enhances the quality, completeness, and relevance of the circuit's content by leveraging the diverse expertise and perspectives of multiple collaborators. It encourages active participation, dialogue, and consensus-building, ultimately leading to more comprehensive and well-rounded circuits.

Moreover, the collaborative authoring feature streamlines the process of circuit creation and maintenance, reducing duplication of efforts and ensuring that the most up-to-date information is readily available to all collaborators. It enables teams to work efficiently, share knowledge effectively, and make informed decisions based on a shared understanding of the circuit's content.

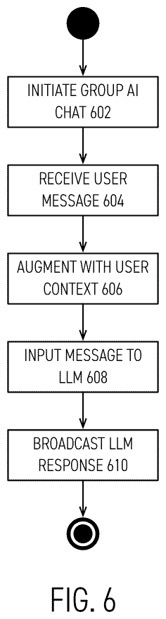

FIG. 6 is a flow diagram illustrating a method for facilitating a group chat within a circuit according to some embodiments of the disclosure.

In step 602, the method can include initiating a group chat session within a circuit.

This step involves a user, typically a circuit collaborator or participant, starting a group chat session within the context of a specific circuit. The group chat session enables multiple users to engage in real-time communication, share ideas, and discuss topics related to the circuit's content.

The initiation of the group chat session may be triggered through various actions, such as clicking on a chat icon or button within the circuit interface, selecting a group of collaborators to start a conversation, or joining an existing chat session. The system may provide options to customize the chat session, such as setting a topic, defining participant roles, or specifying notification preferences.

In step 604, the method can include receiving messages from chat participants.

Once the group chat session is initiated, participants can start sending messages to the chat. They can type their messages in a chat input field and submit them to the conversation. The system receives these messages in real-time and processes them for distribution to other participants.

The messages can include plain text, formatted text, emojis, images, links, or other supported media types. The system may apply formatting and styling to the messages based on predefined templates or user preferences to enhance readability and visual appeal.

As messages are received, the system may perform various preprocessing steps, such as parsing the message content, extracting relevant information, or applying filters to remove any inappropriate or spammy content. These preprocessing steps help ensure the quality and integrity of the chat conversation.

In general, the following discussion focuses on user messages being answered by a large language model. However, the chat interface may also support user-to-user messages that represent human conversations that can be displayed along with LLM-generated answers. Such user-to-user messages may be imitated by selecting a recipient and sending the message to the recipient. Further, the chat interface may also support direct or private messages.

In step 606, the method can include augmenting the messages with contextual information based on the chat participants' user contexts.

To enrich the chat experience and provide more meaningful interactions, the system augments the received messages with contextual information derived from the chat participants' user contexts. The user context represents a collection of data and preferences associated with each individual participant, such as their profile information, interests, expertise, or interaction history within the circuit.

The system analyzes the content of each message and matches it against the user contexts of the participants. It identifies relevant keywords, topics, or entities within the message and cross-references them with the participants' profiles and preferences. Based on this analysis, the system generates contextual information to supplement the original message.

For example, if a participant mentions a specific term or concept related to their area of expertise, the system may automatically provide a brief definition, a link to additional resources, or a suggestion for related topics to explore. If a participant shares a link to an external article, the system may fetch a summary or highlight key points from the article to provide a quick overview to other participants.

The augmentation of messages with contextual information helps participants have more informed and productive conversations. It saves time by providing relevant details and resources directly within the chat interface, reducing the need for participants to manually search for additional information.

In step 608, the method can include inputting the augmented messages into a large language model for generating a response.

To generate meaningful and context-aware responses to the chat messages, the system utilizes a language model, such as GPT (Generative Pre-trained Transformer) or BERT (Bidirectional Encoder Representations from Transformers). These language models are trained on vast amounts of text data and can generate human-like responses based on the input provided.

The system takes the augmented messages, along with the associated contextual information, and feeds them into the language model. The language model processes the input, considering the context and the conversational flow, and generates a response that is relevant and coherent.

The generated response may include a direct answer to a question, a suggestion for further discussion, or a synthesized summary of the key points discussed so far. The language model aims to provide a response that is informative, engaging, and aligned with the tone and style of the conversation.

To ensure the quality and appropriateness of the generated responses, the system may apply additional filtering and moderation techniques. It may check the responses against predefined rules, such as avoiding offensive language, maintaining a professional tone, or adhering to specific guidelines set by the circuit administrators.

In step 610, the method can include broadcasting the generated response to all chat participants.

Once the language model generates a response, the system broadcasts it to all participants in the group chat session. The response appears as a message within the chat interface, clearly indicating that it was generated by the system.

The broadcasting of the generated response ensures that all participants receive the same information and can continue the conversation based on the provided input. The system may apply formatting or styling to the generated response to distinguish it from user-generated messages, enhancing clarity and readability.

Participants can then read the generated response, react to it, or build upon it by sending additional messages. The group chat continues to evolve as participants engage in further discussions, ask questions, or provide their own insights and perspectives.

Throughout the group chat session, the system actively listens to the ongoing conversation, continuously receiving new messages and generating responses as needed. It adapts to the flow of the conversation, taking into account the most recent messages and the evolving user contexts to provide relevant and timely responses.

The group chat functionality described in FIG. 6 enhances collaboration and knowledge sharing within the circuit management system. It enables participants to have interactive and dynamic discussions, leveraging the power of language models to generate informative and context-aware responses.

By augmenting messages with contextual information and generating intelligent responses, the system facilitates more effective communication and helps participants explore ideas, share insights, and make informed decisions. The group chat becomes a central hub for collaboration, fostering a sense of community and enabling participants to learn from each other's expertise.

Moreover, the integration of language models in the group chat functionality opens up new possibilities for knowledge discovery and synthesis. The generated responses can introduce new perspectives, highlight connections between different ideas, or provide summaries and key takeaways from the conversation. This helps participants navigate complex topics, identify patterns, and derive valuable insights from the collective knowledge shared within the chat.

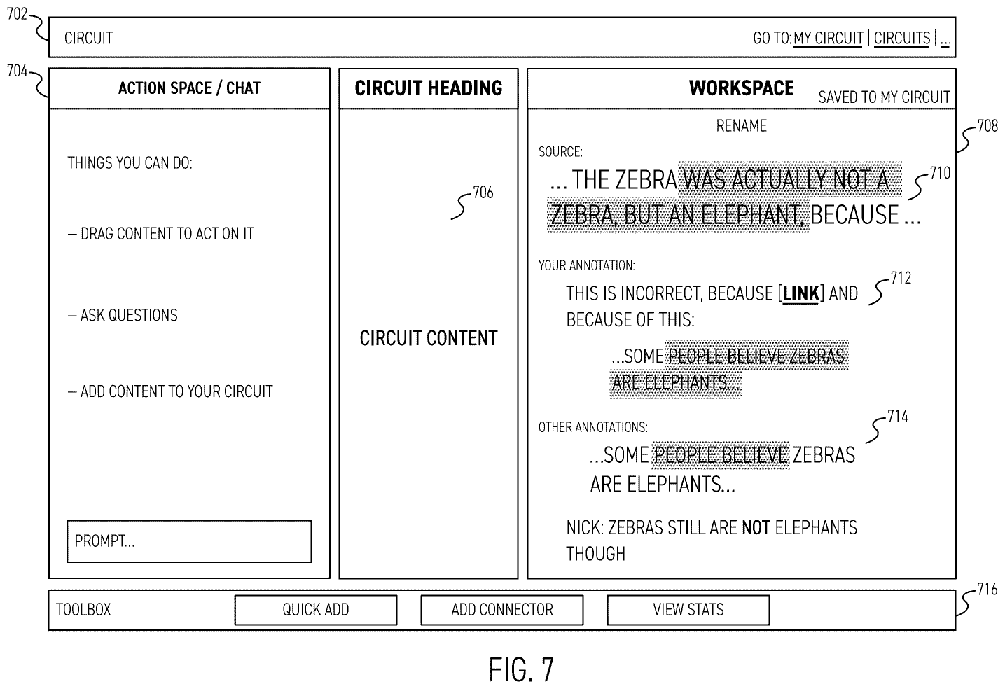

FIG. 7 is a block diagram illustrating a user interface for a circuit workspace, illustrating various features for annotating, referencing, and interacting with circuit content according to some embodiments of the disclosure.

As illustrated, the UI includes a header 702 with general site navigation.

This header 702 provides users with quick access to essential features and sections of the circuit management system. The navigation menu within the header allows users to easily switch between different circuits, access their personal profile, and navigate to other key areas of the system, such as a dashboard, settings, or help resources.

The UI further includes a chatbot interface 704 that enables users to interact with the circuit using natural language.

The chatbot interface leverages advanced natural language processing (NLP) and machine learning techniques (e.g., LLMs including RAG-based LLMs) to provide users with a conversational and intuitive way to explore and interact with the circuit's content (e.g., documents, annotations, etc.). Users can ask questions, request information, or provide instructions to the chatbot, which interprets the user's input and generates relevant responses or actions. As discussed, when implemented using RAG-based LLMs the chatbot can provide highly relevant and contextually relevant answers to user questions.

The chatbot interface 704 may include a text input field where users can type their queries or commands, as well as a display area where the chatbot's responses are presented. In some implementations, users can drag and drop documents or parts of documents from within the circuit into the chatbot interface to interact with or inquire about specific content; further, users may drag and drop documents or parts of documents from within the circuit into the workspace area 708 to edit and work on documents. The chatbot may utilize visual elements, such as cards, images, or formatted text, to enhance the clarity and readability of its responses. Additionally, the chatbot may provide suggestions or prompts to guide users in their interactions and help them discover relevant content or features within the circuit. In some implementations, the chatbot interface 704 can display circuit documents or representations thereof (e.g., snippets, thumbnails, etc.).

As illustrated, the UI includes a circuit viewer 706 that displays the content of the selected circuit.

The circuit viewer 706 is a central component of the workspace, providing a visual representation of the circuit's documents, data, and other associated resources. It presents the content in a structured and organized manner, allowing users to navigate and explore the circuit's information easily. The circuit viewer 706 may employ various visualization techniques to enhance readability and comprehension, such as pagination, scrolling, or dynamic loading to handle large volumes of content seamlessly. It may also provide options for zooming, filtering, or searching within the displayed content, enabling users to focus on specific sections or find relevant information quickly.

The circuit viewer 706 may incorporate interactive elements, such as hyperlinks, cross-references, or expandable/collapsible sections, to facilitate navigation and exploration of related content within the circuit. It can also support multimedia content, such as images, videos, or embedded files, enhancing the richness and diversity of the circuit's information.

The UI further includes a workspace area 708 that allows users to annotate, organize, and interact with the circuit content.

The workspace area 708 is a flexible and interactive environment where users can engage with the circuit's content in various ways. It provides tools and features for annotating, commenting, and organizing information, enabling users to add their own insights, interpretations, and personal notes to the circuit. Within the workspace area 708, users can select specific portions of the circuit content, such as text snippets, images, or data points, and create annotations associated with those selections.

The UI further includes a snippet 710 from a circuit document with a portion of the text highlighted for annotating.

This element represents a specific instance of a user interacting with the circuit content within the workspace. In general, the workspace area 708 serves as an environment where users can work on information for themselves, collaborate with others, or prepare content to share with specific audiences. The user has selected a portion of text from a document within the circuit and highlighted it, indicating their intention to create an annotation associated with that text snippet. The highlighted text serves as a visual cue, drawing attention to the specific section of interest and providing a clear indication of the scope and context of the annotation they are about to create.

The UI further includes the viewer's annotation 712 associated with the highlighted text snippet.

This element represents the annotation created by the current user (the viewer) in response to the highlighted text. The annotation is displayed in close proximity to the highlighted text, establishing a clear visual connection between the content and the user's thoughts or comments. The annotation may include the user's name or identifier, timestamp, and the actual content of the annotation. The content can be in the form of text, formatted using rich text editing capabilities, or enhanced with additional elements such as links, images, or attachments.

The viewer's annotation serves as a personal note or interpretation related to the highlighted text. It captures the user's insights, questions, or contextual information that adds value to the original content. These annotations can be personal reflections or comments intended for a specific audience with whom the workspace output is being shared. Other users accessing the circuit can view and benefit from these annotations, gaining additional perspectives and knowledge shared by the viewer.

The UI further includes other annotations 714 layered on top of the viewer's annotation, representing the concept of layered annotations.

Layered annotations enable multiple users to contribute their own annotations on top of existing ones, creating a hierarchical structure of comments and discussions. The layered annotations are visually distinguished from the base annotation, using different colors, indentation, or other visual cues to indicate the hierarchy and relationships between the annotations. Each layer represents a distinct user's contribution, allowing for multiple perspectives and discussions to evolve around the same piece of content.

Users can interact with layered annotations through an intuitive interface that allows for expanding or collapsing annotation layers. This enables users to navigate through different levels of commentary, focusing on specific perspectives or exploring the full depth of discussions. The system provides visual cues, such as indentation or color coding, to indicate the hierarchy of annotations, making it easy for users to understand the relationship between different layers of commentary.

Users can expand or collapse the layered annotations, providing a flexible way to navigate and explore the different levels of commentary. They can read through the annotations, respond to specific points, or add their own annotations to the existing layers, fostering a collaborative and iterative process of knowledge sharing and discussion.

The concept of layered annotations promotes rich and contextual conversations around the circuit content. It enables users to build upon each other's ideas, ask clarifying questions, provide additional references, or offer alternative viewpoints. The layered structure allows for a more organized and focused discussion, making it easier to follow the flow of thoughts and ideas related to a specific section of the content.

The UI further includes a toolbar 716 that provides various options and actions for interacting with the circuit and the workspace.

The toolbar 716 is a collection of icons, buttons, or menu items that offer quick access to frequently used features and functionalities. It acts as a control panel for the user to perform specific actions or access additional tools within the workspace. The toolbar may include options such as, but limited to, the following.

Quick Add: This feature allows users to quickly add new content or resources to the circuit without navigating away from the current view. It may include options to add text, images, links, or files, enabling users to seamlessly integrate additional information into the circuit.

Add Connector: This option enables users to establish connections or relationships between different elements within the circuit or across multiple circuits. Users can create logical links, associations, or dependencies, helping to organize and structure the information in a meaningful way.

View Stats: This feature provides users with insights and analytics related to the circuit's usage, engagement, and performance. It may display metrics such as the number of views, annotations, contributors, or activity levels, giving users a quantitative understanding of the circuit's impact and reach.

Other options in the toolbar may include tools for formatting text, applying tags or labels, searching within the circuit, or accessing help and documentation. The specific options available in the toolbar may vary based on the user's role, permissions, and the current context of the workspace.

The toolbar enhances the user experience by providing a centralized and easily accessible set of tools and actions. It streamlines common tasks, reduces the need for navigating through complex menus, and allows users to focus on their primary activities within the workspace.

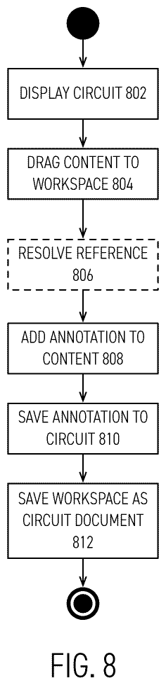

FIG. 8 is a flow diagram illustrating a method for utilizing a circuit workspace to annotate and reference content within a circuit according to some embodiments of the disclosure.

In step 802, the method can include displaying a circuit within a workspace interface.

This step involves rendering the selected circuit's content and structure within the workspace interface, as depicted in FIG. 7. The circuit's documents, data, and associated resources are presented in a visually organized and navigable manner, allowing users to explore and interact with the information effectively.

The display of the circuit may include various formatting and presentation options, such as pagination, scrolling, or dynamic loading, to ensure a smooth and responsive user experience. The interface may also provide search and filtering capabilities to help users quickly locate specific pieces of information within the circuit.

In step 804, the method can include enabling users to drag and drop content from the circuit (or from other sources) into the workspace area.

This step facilitates the seamless integration of circuit content into the workspace environment. Users can select specific elements from the displayed circuit, such as text snippets, images, or data points, and drag them into the designated workspace area (as depicted in FIG. 7 for example).

The drag-and-drop functionality provides an intuitive and efficient way for users to isolate and focus on specific pieces of content for further analysis, annotation, or reference. It allows users to create a personalized collection of relevant information within the workspace, making it easier to organize and work with the selected content.

The method may employ various visual cues and animations to guide users through the drag-and-drop process, ensuring a smooth and intuitive interaction. The workspace area may highlight drop targets or provide visual feedback to confirm the successful placement of the dragged content.

In step 806, the method can include resolving references to the original circuit content for the dragged and dropped elements.

When content is dragged from the circuit and dropped into the workspace, the method establishes and maintains references to the original source material. This step ensures that the workspace content remains linked to its original context within the circuit, allowing users to easily trace back and access the full context of the information.

The resolution of references may involve capturing metadata associated with the dragged content, such as the document identifier, page number, or specific location within the circuit. This metadata is stored alongside the workspace content, creating a persistent link between the workspace element and its corresponding circuit source.

By maintaining these references, the method enables users to quickly navigate back to the original circuit content for further exploration or context. It also facilitates the synchronization of updates and changes between the workspace and the circuit, ensuring that the workspace content remains up to date with any modifications made to the source material.

In step 808, the method can include allowing users to add annotations to the content within the workspace.

Once the content is available in the workspace, users can begin adding annotations to provide their insights, interpretations, or contextual information. The workspace interface provides tools and features for creating and managing annotations, as illustrated in FIG. 7.

Users can select specific portions of the content, such as text snippets or images, and associate annotations with those selections. The annotations can include comments, explanations, questions, tags, or any other relevant information that enhances the understanding or value of the selected content.

The method may provide a rich text editor or formatting options to allow users to structure and style their annotations effectively. Users can use formatting features like bold, italic, underline, or lists to emphasize key points or organize their thoughts coherently.

The workspace interface may also support collaborative annotation, enabling multiple users to contribute their own annotations to the same piece of content. Users can view, reply to, or build upon each other's annotations, fostering a collaborative environment for knowledge sharing and discussion.

In step 810, the method can include saving the annotations and associating them with the corresponding circuit content. Additionally, in some implementations, the method can include an option to save the entire workspace as a cohesive unit, making it available within the circuit and accessible to anyone with whom it is shared. This feature allows users to preserve and distribute their curated collections of content, annotations, and insights as a comprehensive resource.

As users create annotations within the workspace, the method ensures that these annotations are persistently linked to the relevant circuit content. The annotations, along with their associated metadata and references, are saved and stored in a structured manner, allowing for efficient retrieval and management.

The saving process may involve creating a new data object or document that encapsulates the annotation content, metadata, and references to the original circuit material. This annotation object is then stored in a designated annotation repository or database, which is integrated with the circuit management system.

The association between the annotations and the circuit content is maintained through the resolved references established in step 806. This association enables the annotations to be displayed alongside the corresponding circuit content when viewed by other users, providing additional context and insights.

The method may also implement versioning or history tracking for annotations, allowing users to review and compare different versions of annotations over time. This feature enables users to see how the understanding or interpretation of specific content has evolved and facilitates the tracking of changes and contributions made by different users.

In step 812, the method can include saving the workspace itself as a new document within the circuit.

In addition to saving individual annotations, the method allows users to save the entire workspace as a standalone document within the circuit. This step captures the current state of the workspace, including the selected content, annotations, and any other organizational elements or structures created by the user.

By saving the workspace as a new document, users can preserve their work and share it with others as a self-contained resource. The workspace document encapsulates the curated content, annotations, and contextual information, providing a coherent and focused view of the information that is relevant to a specific topic or purpose.

The saved workspace document becomes a part of the circuit, accessible and discoverable by other users who have appropriate permissions. It can be searched, referenced, and linked to other documents or circuits, enhancing the interconnectedness and discoverability of knowledge within the system.

Users can choose to make their workspace documents private, sharing them only with specific collaborators, or publish them for wider access within the organization or community. The sharing and collaboration features of the circuit management system enable users to build upon each other's workspaces, fostering a collaborative and iterative approach to knowledge creation and dissemination.

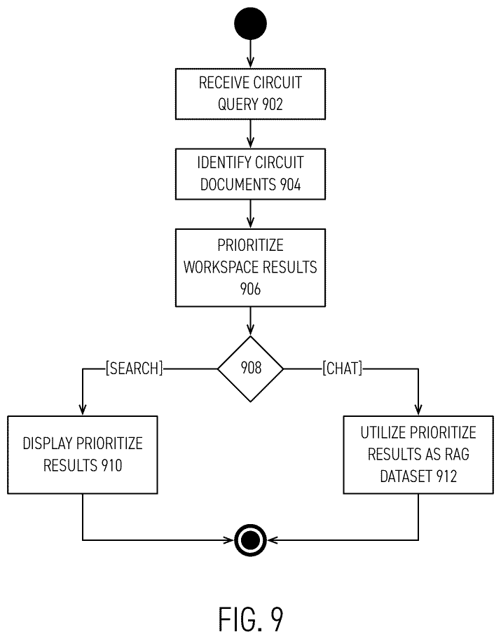

FIG. 9 is a flow diagram illustrating a method for prioritizing circuit documents based on user queries according to some embodiments of the disclosure.

In step 902, the method can include receiving a user query related to a specific circuit.

This step involves capturing a user's information request or search query within the context of a particular circuit. The user interacts with the circuit interface, either through a dedicated search bar or by entering their query in the chat or workspace area, as depicted in FIG. 7 (chatbot interface 704).

The user's query can be in the form of keywords, phrases, or natural language questions expressing their information needs or topics of interest. The query may relate to specific concepts, ideas, or problems that the user seeks to explore or find answers to within the circuit's content.

The method may employ various input validation and preprocessing techniques to ensure the query is well-formed and suitable for further processing. This can include removing any special characters, normalizing the query text, or applying stemming or lemmatization to standardize the query terms.

In step 904, the method can include identifying relevant documents within the circuit based on the user query.

Upon receiving the user query, the method initiates a search process to identify the most relevant documents within the circuit that can potentially satisfy the user's information needs. This step involves analyzing the content of the circuit's documents and determining their relevance to the user's query.

The method may employ various information retrieval techniques, such as embedding or vector search, keyword matching, semantic analysis, or machine learning algorithms, to assess the relevance of each document. It may consider factors such as the presence and frequency of query terms within the document, the semantic similarity between the query and the document's content, the vector distance between a query and the documents, or the document's overall importance and authority within the circuit.

The relevance scoring process assigns a relevance score or ranking to each document based on its estimated ability to address the user's query. Documents with higher relevance scores are considered more likely to contain information that is pertinent to the user's information needs.

In step 906, the method can include prioritizing workspace documents that are associated with the circuit.

In addition to the circuit's primary documents, the method gives special consideration to workspace documents that have been created and saved within the circuit, as described in FIG. 8 (step 812). These workspace documents represent curated collections of content, annotations, and insights that users have actively engaged with and found valuable.

The method recognizes the significance of these workspace documents and prioritizes them in the search results. It considers factors such as the relevance of the workspace document to the user's query, the recency of the workspace document's creation or modification, and the level of user engagement or collaboration associated with the workspace document. In some implementations, the method can adjust the ranking of workspaces based on the value added by annotations (alone or in combination with other techniques). For example, workspaces having high value annotations may be ranked higher than other workspaces or circuit documents. In some implementations, whether annotations are high value can be determined using an LLM or other artificial intelligence/machine learning approach, a content ranking algorithm, or by human editors (or a combination thereof).

By prioritizing workspace documents, the method acknowledges the value of user-generated content and the collective knowledge captured within these focused and contextualized resources. It ensures that the search results not only include the primary circuit documents but also highlight the most relevant and valuable workspace documents that can provide additional insights and perspectives.

The prioritization process may involve adjusting the relevance scores of workspace documents, applying boosting factors, or presenting them prominently in the search results interface. The method may also consider the user's context, such as their role, expertise, or previous interactions with the workspace documents, to personalize the prioritization and ensure the most relevant results are surfaced.

In step 908, the method can include determining the type of user query and selecting the appropriate response format.

This step involves analyzing the user's query to determine its nature and intent. The method examines the query's structure, keywords, and any additional context provided by the user to classify the query into different categories or types.

Common query types may include, but are not limited to, the following.

Informational queries: These are queries where the user seeks specific information or facts about a topic. The user expects a direct and concise answer to their question.

Navigational queries: These queries indicate that the user wants to navigate to a specific document or section within the circuit. The user may provide the name or identifier of the desired content.

Exploratory queries: These queries suggest that the user is interested in exploring a broader topic or concept. The user may be looking for an overview, related ideas, or diverse perspectives on the subject.

Based on the identified query type, the method selects the most appropriate response format to present the search results. For informational queries, the method may prioritize displaying a concise summary or excerpt from the most relevant document that directly answers the user's question. For navigational queries, the method may provide direct links or shortcuts to the requested content, enabling quick access to the desired information.

For exploratory queries, the method may opt for a more comprehensive response format, such as presenting a list of relevant documents, grouped by subtopics or categories. It may also include visualizations, such as knowledge graphs or concept maps, to help the user navigate and explore the relationships between different ideas within the circuit.

The selection of the appropriate response format provides the most helpful and efficient way for the user to access and consume the information they need. It takes into account the user's expectations, the nature of their query, and the characteristics of the relevant documents within the circuit.

In step 910, if the user query is a search query, the method can include displaying the prioritized search results to the user.

If the user's query is determined to be a search query, where the user is explicitly seeking information from the circuit's content, the method presents the prioritized search results to the user in a clear and organized manner.

The search results interface may include a list of the most relevant documents, ranked based on their relevance scores and any additional prioritization factors applied in steps 904 and 906. Each search result may display the document's title, a brief summary or excerpt highlighting the relevant content, and any other metadata or contextual information that aids in understanding the document's significance.

The method may employ pagination or infinite scrolling techniques to allow users to navigate through the search results efficiently. It may also provide options for users to filter or refine the results based on various criteria, such as document type, creation date, or associated tags or categories.

The search results interface may incorporate visual cues or indicators to differentiate between primary circuit documents and prioritized workspace documents. This distinction helps users quickly identify and access the most relevant and valuable content, including user-generated annotations and insights.

In addition to the document list, the search results may include featured snippets or quick answers that directly address the user's query, saving them time and effort in finding the desired information. These snippets may be extracted from the most relevant documents or generated using natural language processing techniques to provide concise and accurate responses.

Overall, the display of prioritized search results aims to guide users towards the most relevant and useful content within the circuit, enabling them to quickly locate the information they need and explore related concepts or ideas.

In step 912, if the user query is a chat or conversational query, the method can include utilizing the prioritized results as a knowledge base for generating conversational responses.

If the user's query is determined to be a chat or conversational query, where the user is engaging in a dialogue or seeking interactive assistance, the method employs the prioritized results as a foundation for generating meaningful and contextually relevant responses.

In this case, the prioritized documents, including both primary circuit documents and workspace documents, serve as a knowledge base for the conversational engine. The method leverages the information contained within these documents to formulate accurate and informative responses to the user's queries.

The conversational engine may utilize large language models, natural language processing techniques, such as named entity recognition, sentiment analysis, or intent classification, to understand the user's query and determine the most appropriate response strategy. It may also consider the user's previous interactions, preferences, or context to personalize the conversation and provide more targeted and relevant information.

The method (via, for example, an LLM) may employ various techniques to generate conversational responses, such as, but not limited to the following.

In some implementations, the method can include retrieving and presenting relevant excerpts or summaries from the prioritized documents that directly address the user's query.

In some implementations, the method can include synthesizing information from multiple documents to provide a comprehensive and coherent response, taking into account the relationships and context between different pieces of information.

In some implementations, the method can include generating natural language responses using language models or templates, incorporating the knowledge extracted from the prioritized documents.

In some implementations, the method can include engaging in multi-turn conversations, where the method maintains the context of the dialogue and builds upon previous interactions to provide more accurate and nuanced responses.

The conversational responses may include not only textual information but also interactive elements, such as buttons, links, or visualizations, to facilitate further exploration or action by the user. The method may also incorporate feedback mechanisms, allowing users to rate the relevance or helpfulness of the responses, which can be used to continuously improve the conversational engine's performance.

By utilizing the prioritized results as a knowledge base, the method enables users to engage in natural and informative conversations within the circuit interface. It leverages the collective knowledge captured within the circuit's documents and user-generated content to provide accurate, relevant, and contextually appropriate responses to user queries.

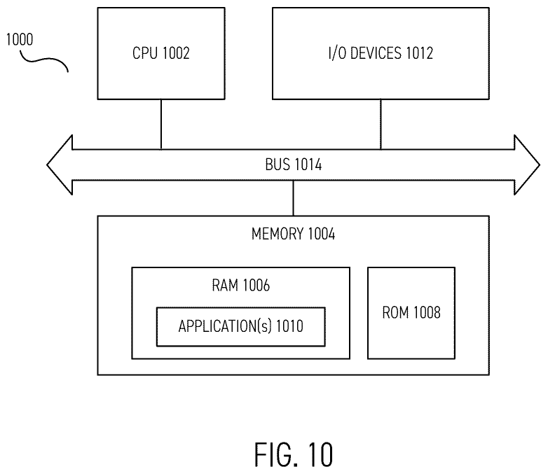

FIG. 10 is a block diagram illustrating a computing device that may be used to implement various embodiments of the disclosure.

As illustrated, the device 1000 includes a processor or central processing unit (CPU) such as CPU 1002 in communication with a memory 1004 via a bus 1014. The device also includes one or more input/output (I/O) or peripheral devices 1012. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 1002 may comprise a general-purpose CPU. The CPU 1002 may comprise a single-core or multiple-core CPU. The CPU 1002 may comprise a system-on-a-chip (SoC) or a similar embedded system. In some embodiments, a graphics processing unit (GPU) may be used in place of, or in combination with, a CPU 1002. Memory 1004 may comprise a memory system including a dynamic random-access memory (DRAM), static random-access memory (SRAM), Flash (e.g., NAND Flash), or combinations thereof. In one embodiment, the bus 1014 may comprise a Peripheral Component Interconnect Express (PCIe) bus. In some embodiments, the bus 1014 may comprise multiple busses instead of a single bus.

Memory 1004 illustrates an example of a non-transitory computer storage media for the storage of information such as computer-readable instructions, data structures, program modules, or other data. Memory 1004 can store a basic input/output system (BIOS) in read-only memory (ROM), such as ROM 1008 for controlling the low-level operation of the device. The memory can also store an operating system in random-access memory (RAM) for controlling the operation of the device.

Applications 1010 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 1006 by CPU 1002. CPU 1002 may then read the software or data from RAM 1006, process them, and store them in RAM 1006 again.

The device may optionally communicate with a base station (not shown) or directly with another computing device. One or more network interfaces in peripheral devices 1012 are sometimes referred to as a transceiver, transceiving device, or network interface card (NIC).

An audio interface in peripheral devices 1012 produces and receives audio signals such as the sound of a human voice. For example, an audio interface may be coupled to a speaker and microphone (not shown) to enable telecommunication with others or generate an audio acknowledgment for some action. Displays in peripheral devices 1012 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 1012 may comprise any input device arranged to receive input from a user. An illuminator in peripheral devices 1012 may provide a status indication or provide light. The device can also comprise an input/output interface in peripheral devices 1012 for communication with external devices, using communication technologies, such as USB, infrared, Bluetooth®, or the like. A haptic interface in peripheral devices 1012 provides tactile feedback to a user of the client device.

A GPS receiver in peripheral devices 1012 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving a request for a circuit, wherein the circuit comprises a collection of electronic documents and resources organized based on context and relevance;
loading circuit content and user context associated with the request;
determining a circuit layout based on the user context and circuit content;
generating a circuit user interface based on the circuit layout, wherein generating the circuit user interface comprises selecting a layout template based on at least one of a manual user specification, a predefined circuit type, or an AI-based content analysis; and
outputting the circuit user interface to a client device.

2. The method of claim 1, further comprising analyzing new content from specific sources by flagging new documents for approval when not received from a allowlisted source; and
prompting an author to review annotations on updated documents before incorporating the updated documents into the circuit.

3. The method of claim 1, wherein determining the circuit layout comprises: determining a semantic meaning of an intent statement associated with the circuit using natural language processing; and generating a layout that aligns the circuit with the semantic meaning of the intent statement.

4. The method of claim 1, further comprising: providing a visual curation interface that allows an author to manually position widgets within the circuit layout while maintaining responsive flow of content.

5. The method of claim 1, wherein generating the circuit user interface comprises: creating a layout that combines manually curated sections with dynamically generated sections.

6. The method of claim 1, further comprising: dynamically adjusting the circuit layout based on user interactions and queries while preserving manually defined elements.

7. A method comprising:
initiating a collaboration session for a circuit, wherein the circuit comprises a collection of electronic documents and resources;
receiving changes to content of the circuit from multiple collaborators;
resolving conflicts between the changes by applying at least one of: chronological prioritization, granular merging, user-defined conflict resolution rules, or AI-assisted conflict resolution;
incorporating resolved changes into the circuit; maintaining a version history of the circuit, including records of changes made by each collaborator; and
providing real-time updates and notifications to collaborators of changes to the content of the circuit.

8. The method of claim 7, further comprising: implementing a layered annotation system that allows users to add annotations on top of existing annotations, creating a hierarchical structure of comments and discussions.

9. The method of claim 7, wherein resolving detected conflicts comprises: employing an AI-assisted conflict resolution system that analyzes semantic content of conflicting changes and suggests optimal merging strategies.

10. The method of claim 7, further comprising: providing a shared chat interface within the collaboration session that integrates with an AI assistant, allowing multiple users to collectively interact with and receive responses from the AI assistant.

11. The method of claim 7, further comprising: automatically adjusting a visibility and accessibility of collaborative features based on user roles and circuit permissions.

12. The method of claim 7, wherein incorporating resolved changes into the circuit comprises:
updating linked references across interconnected circuits to maintain consistency when collaborative changes change shared content.

13. A method comprising:
displaying a circuit;
enabling users to drag and drop content from the circuit into a workspace area; resolving references to original circuit content for dragged and dropped elements;
allowing users to add annotations to the content within the workspace area, wherein the annotations comprise at least one of comments, explanations, questions, or tags;
saving the annotations and associating them with corresponding circuit content;
implementing a layered annotation structure, wherein subsequent annotations can be added as additional layers to existing annotations;
providing tools for users to navigate and interact with the layered annotation structure; and
saving the workspace area, including the annotations and organizational structure, as a new document within the circuit.

14. The method of claim 13, further comprising: implementing a reference-first system that maintains active links between dragged content and its original source, enabling users to trace information back to its origin within the circuit.

15. The method of claim 13, wherein saving the annotations comprises: storing annotations separately from the original circuit content, allowing users to toggle visibility of personal and shared annotations independently.

16. The method of claim 13, further comprising: providing multiple visualization options for dragged items in the workspace area, including full content display and representative reference formats.

17. The method of claim 13, further comprising: automatically applying workspace annotations to the original circuit content, making additional information visible to other circuit users.

18. The method of claim 13, further comprising: generating a knowledge graph based on connections and annotations created in the workspace area, visualizing relationships between different pieces of content.

19. The method of claim 13, wherein saving the workspace area as a new document comprises: assigning the new document associated with the workspace area a higher search rank within the circuit.

20. The method of claim 13, further comprising: providing an interface within the workspace area that enables users to add content to other circuits, manage connectors, and view engagement.
